(19) United States
(12) Patent Application Publication
(10) Pub. No.: US 2002/0116269 A1
(43) Pub. Date: Aug. 22, 2002

(54) Advertisement system and advertisement display method

(75) Inventor: Kazuhiro Ishida, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/077,765

(22) Filed: Feb. 20, 2002

(30) Foreign Application Priority Data
Feb. 21, 2001 (JP) 2001-044747

(51) Int. Cl. G06F 17/60

(52) U.S. Cl. 705/14; 709/318

(57) ABSTRACT

An advertisement system includes a portable communication terminal, terminal management device, and advertisement broadcast device. The portable communication terminal can display an advertisement on a standby screen. The terminal management device has a notification unit, registration unit, and display control unit. When a registration request for first information representing that the portable communication terminal is an advertisement display terminal and second information representing an advertisement broadcaster designated by the portable communication terminal is issued, the notification unit notifies the advertisement broadcast device of the registration request including the first information in accordance with the second information. When the advertisement broadcast device sends registration acceptance, the registration unit registers the first information and second information. When advertisement data is received from the advertisement broadcast device, the display control unit transmits the received advertisement data to the portable communication terminal, and displays the advertisement data on the standby screen of the portable communication terminal. An advertisement display method is also disclosed.

### BACKGROUND OF THE INVENTION

The present invention relates to an advertisement system and advertisement display method which allow an advertisement broadcaster to control the screen of a portable communication terminal in no-use.

Recent portable telephones can display an image, calendar, or the like on a screen in no-use (so-called standby screen). The user sets and displays his/her favorite characters or image on the standby screen of the portable telephone.

To broadcast advertisement information to users, there is a so-called direct mail advertisement method which broadcasts an advertisement by using general mail or electronic mail. Even if, however, an advertisement is broadcast by this method, the user may not see its contents. For example, if advertisement information is broadcast to portable telephones, whether the broadcast advertisement information is displayed on the display is based on user settings.

### SUMMARY OF THE INVENTION

It is an object of the present invention to provide an advertisement system and advertisement display method capable of reliably displaying advertisement information by using a portable communication terminal.

To achieve the above object, according to the present invention, there is provided an advertisement system comprising a portable communication terminal capable of displaying an advertisement on a standby screen, a terminal management device for managing the portable communication terminal, and an advertisement broadcast device for storing advertisement data provided by an advertisement broadcaster, wherein the terminal management device has notification means for, when a registration request for first information representing that the portable communication terminal is an advertisement display terminal and second information representing an advertisement broadcaster designated by the portable communication terminal is issued, notifying the advertisement broadcast device of the registration request including the first information in accordance with the second information, registration means for registering the first information and the second information when the advertisement broadcast device sends registration acceptance in response to the registration request notification from the notification means, and display control means for, when advertisement data is received from the advertisement broadcast device which is a registration acceptance notification source, transmitting the received advertisement data to the portable communication terminal on the basis of the registered first information and the registered second information, and displaying the advertisement data on the standby screen of the portable communication terminal.

### BRIEF DESCRIPTION OF THE DRAWINGS

FIG. 1 is a block diagram showing an advertisement system according to the first embodiment of the present invention;

FIG. 2 is a sequence chart showing the operation of the advertisement system in FIG. 1;

FIG. 3 is a block diagram showing an advertisement system according to the second embodiment of the present invention;

FIG. 4 is a sequence chart showing the operation of the advertisement system in FIG. 3;

FIG. 5 is a functional block diagram showing a CPU 11 in FIG. 1; and

FIGS. 6A and 6B are functional block diagrams showing CPUs 21 and 31 in FIG. 3.

### DESCRIPTION OF THE PREFERRED EMBODIMENTS

The present invention will be described in detail below with reference to the accompanying drawings.

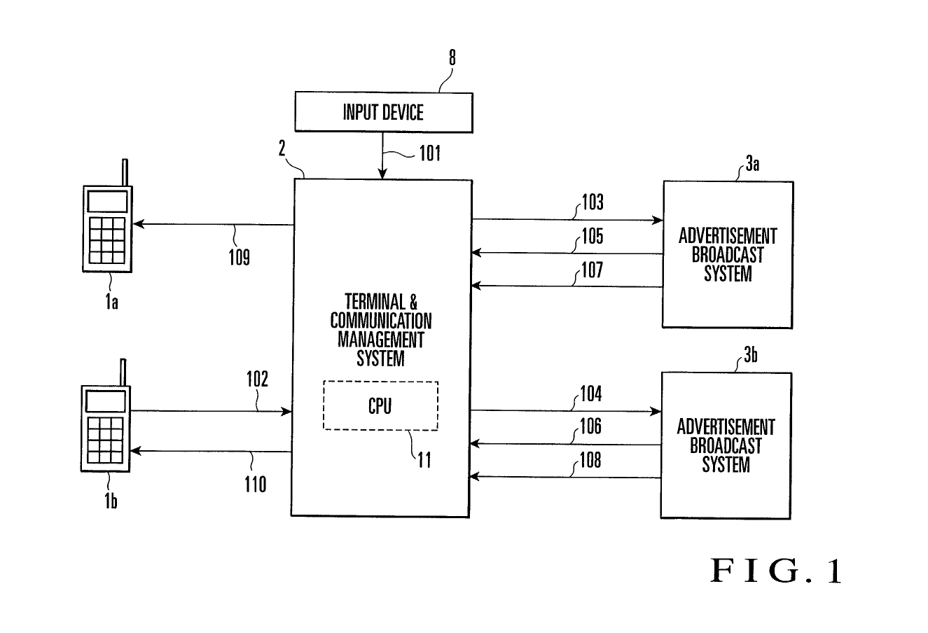

FIG. 1 shows an advertisement system according to the first embodiment of the present invention. In FIG. 1, the advertisement system comprises automatic display terminals 1a and 1b each formed from a portable communication terminal which automatically displays broadcast advertisement information on a standby screen, a terminal & communication management system 2 which manages the automatic display terminals 1a and 1b on the basis of terminal information, and performs communication control of the automatic display terminals 1a and 1b and charging for the automatic display terminals 1a and 1b, advertisement broadcast systems 3a and 3b which broadcast advertisement information to the automatic display terminals 1a and 1b, and an input device 8 which performs registration/cancel of terminal information (terminal identification information such as terminal telephone numbers for identifying the automatic display terminals 1a and 1b) with respect to the terminal & communication management system 2.

The operation of the advertisement system having this arrangement will be explained.

The manager of the advertisement system issues, to the terminal & communication management system 2 by using the input device 8, a registration request 101 for terminal information of the terminals 1a and 1b representing that they are automatic advertisement display terminals, and information representing advertisement broadcast systems (advertisement broadcasters) desired by the terminals 1a and 1b. In this case, the user can issue, via the terminal 1b, a registration request 102 for terminal information of the terminal 1b representing that it is an automatic advertisement display terminal, and information representing an advertisement broadcast system (advertisement broadcaster) desired by the terminal 1b. This registration request method using a user terminal is effective because the user can use his/her terminal to set whether to automatically display an advertisement on his/her terminal.

Assume that the advertisement broadcast systems 3a and 3b are requested to register the terminals 1a and 1b. In this case, the terminal & communication management system 2 issues, to the advertisement broadcast system 3a, a registration notification 103 for information representing that the terminal 1a is an automatic advertisement display terminal and terminal information of the terminal 1a. At the same time, the terminal & communication management system 2 issues, to the advertisement broadcast system 3b, a registration notification 104 for information representing that the terminal 1b is an automatic advertisement display terminal and terminal information of the terminal 1b.

Upon reception of the registration notification from the terminal & communication management system 2, the advertisement broadcast system 3a notifies the terminal & communication management system 2 of registration acceptance/rejection 105 for the terminal 1a in accordance with whether terminal information of the terminal 1a has been registered in the system 3a in advance. The advertisement broadcast system 3b notifies the terminal & communication management system 2 of registration acceptance/rejection 106 for the terminal 1b in accordance with whether terminal information of the terminal 1b has been registered in the system 3b in advance.

If registration of the terminals 1a and 1b is accepted, the terminal & communication management system 2 internally registers terminal information and advertisement broadcast sources (advertisement broadcast systems 3a and 3b). For example, the charge destination of a communication charge can be changed based on these pieces of registered information. If the advertisement broadcast systems 3a and 3b reject registration of the terminals 1a and 1b, the terminal & communication management system 2 sends registration failure notifications to the registration-rejected terminals 1a and 1b.

After the terminal information and advertisement broadcast sources are internally registered in the terminal & communication management system 2, the advertisement broadcast system 3a transmits advertisement data 107 addressed to the terminal 1a to the terminal & communication management system 2. The advertisement broadcast system 3b transmits advertisement data 108 addressed to the terminal 1b to the terminal & communication management system 2. That is, if the advertisement broadcast systems 3a and 3b receive terminal information of the terminals 1a and 1b serving as automatic advertisement display terminals from the terminal & communication management system 2, they can transmit advertisement data at arbitrary timings after registration acceptance settings of the terminals 1a and 1b.

Upon reception of the advertisement data from the advertisement broadcast system 3a, the terminal & communication management system 2 transmits the advertisement data as automatic display data 109 to the designated terminal 1a. Upon reception of the advertisement data from the advertisement broadcast system 3b, the terminal & communication management system 2 transmits the advertisement data as automatic display data 110 to the designated terminal 1b. Upon reception of the automatic display data 109 and 110, the automatic display terminals 1a and 1b automatically display the received data on their standby screens. When the advertisement broadcast system 3b transmits advertisement data addressed to the terminal 1b, the terminal & communication management system 2 does not transmit the advertisement data to the terminal 1b in accordance with the internal registration.

To stop advertisement broadcast to the terminal, the terminal & communication management system 2 is notified of terminal information representing that the target terminal is an automatic advertisement display terminal, and a broadcast source (i.e., advertisement broadcast system 3) desired to stop broadcast. For example, to stop advertisement broadcast to the terminal 1a, an input by the system manager from the input device 8 notifies the terminal & communication management system 2 of terminal information of the terminal 1a serving as an automatic advertisement display terminal and identification information of the advertisement broadcast system 3a desired to stop advertisement broadcast. Then, registration of advertisement broadcast to the terminal 1a is canceled.

To stop advertisement broadcast to the terminal 1b, the user operates the terminal 1b to notify the terminal & communication management system 2 of terminal information of the terminal 1b serving as an automatic advertisement display terminal and identification information of the advertisement broadcast system 3b desired to stop advertisement broadcast. Then, registration of advertisement broadcast to the terminal 1b is canceled. At this time, the terminal & communication management system 2 notifies the advertisement broadcast systems 3a and 3b of cancellation of registration.

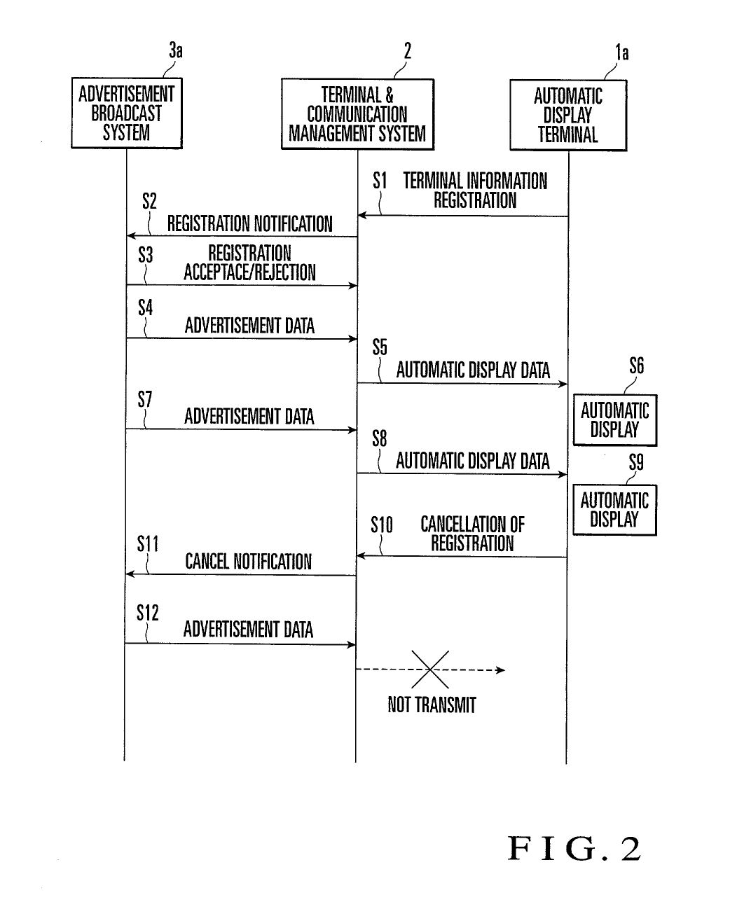

The sequence operation of the above-described advertisement system will be described with reference to FIG. 2. Information representing that the terminal 1a is an automatic advertisement display terminal, and a registration request to the advertisement broadcast system 3a desired by the terminal 1a are input from the input device 8 (step S1). The terminal & communication management system 2 notifies the advertisement broadcast system 3a of the information representing that the terminal 1a is an automatic advertisement display terminal, together with terminal information of the terminal 1a (step S2).

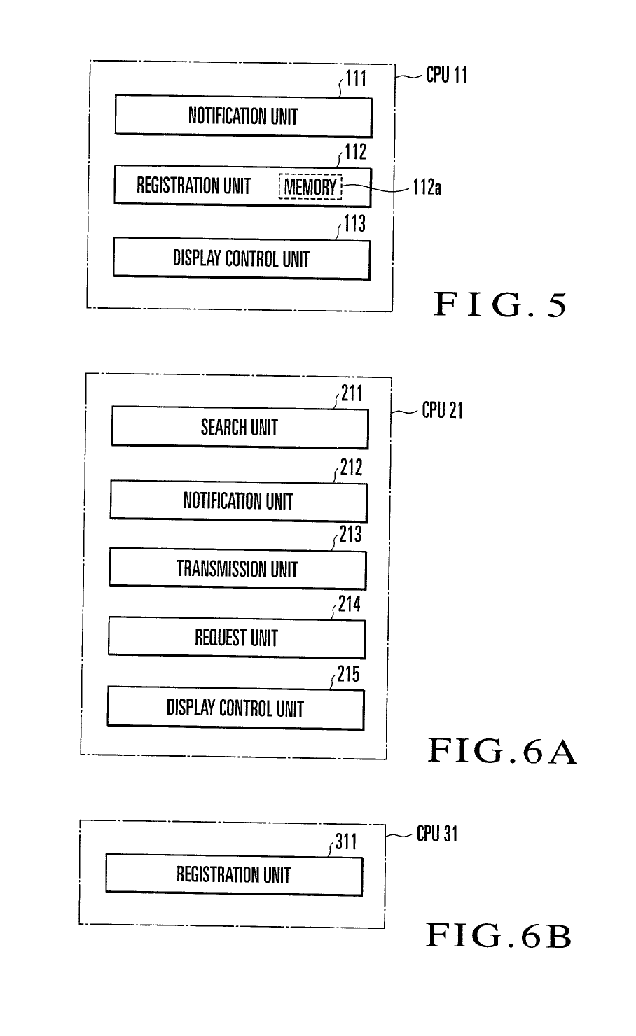

In response to the notification from the terminal & communication management system 2, the advertisement broadcast system 3a sends back registration acceptance/rejection of the terminal 1a to the terminal & communication management system 2 (step S3). If the advertisement broadcast system 3a accepts registration of the terminal 1a, the terminal & communication management system 2 registers the advertisement broadcast source (advertisement broadcast system 3a) in a memory 112a (FIG. 5) in correspondence with the terminal information. If the advertisement broadcast system 3a rejects registration of the terminal 1a, the terminal & communication management system 2 sends a registration failure notification to the registration-rejected terminal 1a.

After registration of the terminal information and advertisement broadcast source is completed in the terminal & communication management system 2, the advertisement broadcast system 3a transmits advertisement data for the terminal 1a to the terminal & communication management system 2 (step S4). Upon reception of the advertisement data from the advertisement broadcast system 3a, the terminal & communication management system 2 transmits the received data as automatic display data to the designated terminal 1a on the basis of the registered information (step S5). The automatic display terminal 1a automatically displays the received automatic display data on its standby screen (step S6).

The advertisement broadcast system 3a transmits the next advertisement data for the terminal 1a to the terminal & communication management system 2 unless registration of the terminal 1a is canceled (step S7). Upon reception of the advertisement data from the advertisement broadcast system 3a, the terminal & communication management system 2 transmits the received data as automatic display data to the designated terminal 1a on the basis of the registered information (step S8). The automatic display terminal 1a automatically displays the received automatic display data on its standby screen (step S9).

To stop advertisement broadcast to the terminal 1a, a registration cancel notification for the terminal 1a is issued from the input device 8 (or terminal 1a) to the terminal & communication management system 2 (step S10). At this time, the input device 8 (or terminal 1a) notifies the terminal & communication management system 2 of terminal information representing that the terminal 1a is an automatic advertisement display terminal, and a broadcast source (advertisement broadcast system 3a) designated to stop advertisement broadcast to the terminal 1a. In response to the registration cancel notification, the terminal & communication management system 2 cancels registration of terminal information of the terminal 1a and registration of corresponding broadcast source information. Further, the terminal & communication management system 2 notifies the advertisement broadcast system 3a of cancellation of registration (step S11). Thereafter, if the advertisement broadcast system 3a transmits advertisement data for the terminal 1a to the terminal & communication management system 2 (step S12), the terminal & communication management system 2 does not broadcast the advertisement data to the terminal 1a.

The above-described sequence operation of the terminal & communication management system 2 is achieved by executing a pre-stored operation program by a CPU (Central Processing Unit) 11. As shown in FIG. 5, the CPU 11 is constituted by functional blocks: a notification unit 111 which executes step S2 in FIG. 2, a registration unit 112 which registers terminal information and the like in the memory 112a after step S3 in FIG. 2, and a display control unit 113 which performs display control in steps S6 and S9 in FIG. 2.

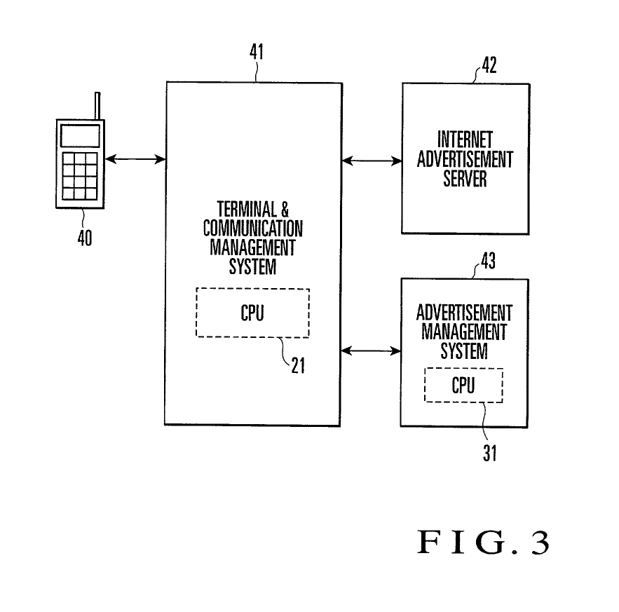

FIG. 3 shows an advertisement system according to the second embodiment of the present invention. In the second embodiment, advertisement data of a specific page on the Internet is displayed on the standby screen of a portable communication terminal.

In FIG. 3, the advertisement system comprises a communication terminal 40 formed from a portable communication terminal which displays broadcast advertisement data on a standby screen, a terminal & communication management system 41 which manages the communication terminal 40 on the basis of terminal information, and performs communication control of the communication terminal 40 and charging for the communication terminal 40, an Internet advertisement server (to be referred to as a server hereinafter) 42 which is connected to the Internet and broadcasts advertisement data of an advertisement page to the communication terminal 40, and an advertisement management system 43 which manages the advertisement page of the server 42.

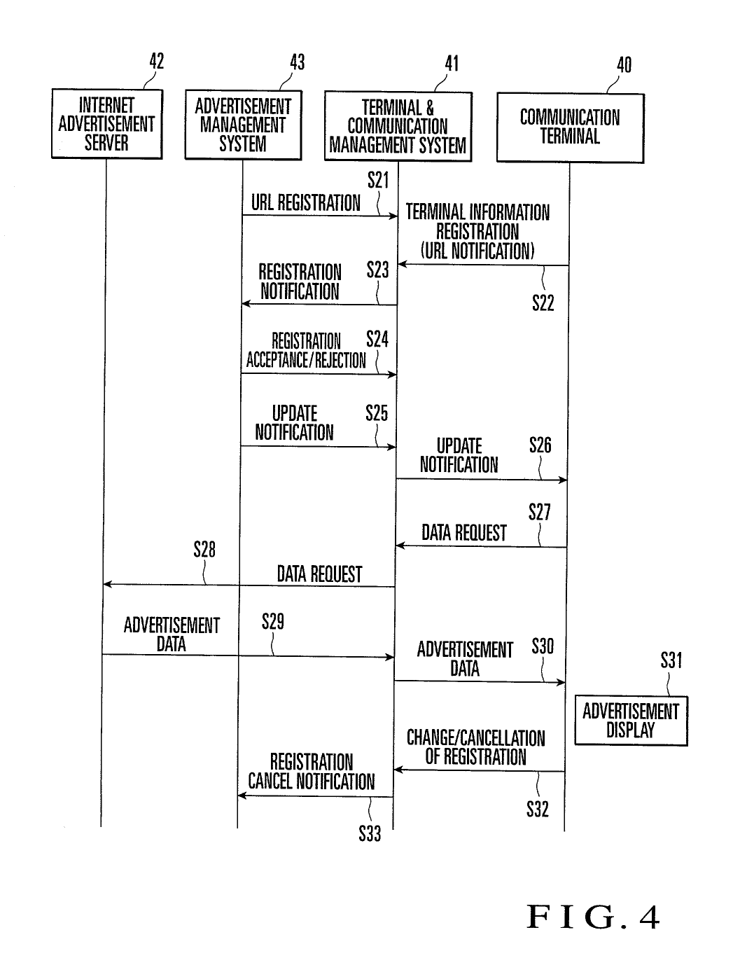

The sequence operation of the advertisement system will be explained with reference to FIG. 4. Prior to broadcast of advertisement data from the server 42 to the communication terminal 40, the advertisement management system 43 registers the URL (Uniform Resource Locator) of an advertisement page on the Internet in the terminal & communication management system 41 (step S21). The user sets an Internet page on the standby screen of the communication terminal 40. Then, the communication terminal 40 notifies the terminal & communication management system 41 of the URL of the page set on the standby screen (step S22).

The terminal & communication management system 41 searches the URLs of advertisement pages registered by the advertisement management system 43 for the URL designated by the communication terminal 40. The terminal & communication management system 41 notifies the advertisement management system 43 of the searched URL (step S23).

The advertisement management system 43 which has received the URL registration notification from the terminal & communication management system 41 notifies the terminal & communication management system 41 of registration acceptance/rejection on the basis of whether the notified URL has been registered (step S24). If the terminal & communication management system 41 receives a registration acceptance notification from the advertisement management system 43, it registers terminal information such as the telephone number of the communication terminal 40, and advertisement management source information (e.g., identification information of the advertisement management system 43). The terminal & communication management system 41 can change the charge destination of a communication charge on the basis of the registered information.

If the terminal & communication management system 41 receives a registration rejection notification from the advertisement management system 43, it notifies the communication terminal 40 of a registration failure.

After terminal information and advertisement management source information are registered by the terminal & communication management system 41, the advertisement management system 43 sends the registered URL addressed to the communication terminal 40 to the terminal & communication management system 41 (step S25). Upon reception of the registered URL addressed to the communication terminal 40 from the advertisement management system 43, the terminal & communication management system 41 sends the registered URL received to the communication terminal 40 (step S26).

The communication terminal 40 which has received the registered URL issues a transmission request for advertisement data of the registered URL to the server 42 (step S27). The advertisement data transmission request from the terminal 40 is temporarily received by the terminal & communication management system 41. Then, the terminal & communication management system 41 notifies the server 42 of this request (step S28). Upon reception of the advertisement data transmission request from the communication terminal 40, the server 42 transmits data of an advertisement page corresponding to the registered URL (step S29). The advertisement page data from the server 42 is temporarily received by the terminal & communication management system 41. This data is further transmitted from the terminal & communication management system 41 to the communication terminal 40 (step S30). Upon reception of the advertisement data, the communication terminal 40 displays it on the standby screen (step S31).

If the contents of an advertisement page are updated, the advertisement management system 43 sends, to the terminal & communication management system 41, an update notification including updated information addressed to the communication terminal 40 and the registered URL (step S25). Upon reception of the update notification from the advertisement management system 43, the terminal & communication management system 41 sends the received update notification to the communication terminal 40 (step S26). At this time, the terminal & communication management system 41 does not notify the communication terminal 40 of update information irrelevant to the registered URL of the communication terminal 40.

The communication terminal 40 which has received the update notification issues a transmission request for advertisement data of the registered URL to the server 42 (step S27). The advertisement data transmission request from the communication terminal 40 is temporarily received by the terminal & communication management system 41. Then, the terminal & communication management system 41 notifies the server 42 of this request (step S28). Upon reception of the advertisement data transmission request from the communication terminal 40, the server 42 transmits corresponding advertisement page data (step S29). The advertisement page data from the server 42 is temporarily received by the terminal & communication management system 41. This data is further transmitted from the terminal & communication management system 41 to the communication terminal 40 (step S30). The communication terminal 40 displays the advertisement data received from the server 42 on the standby screen (step S31).

If the user cancels the settings of the standby screen of the communication terminal 40, the communication terminal 40 sends a registration cancel notification to the terminal & communication management system 41 (step S32). The terminal & communication management system 41 which has received the registration cancel notification cancels registration of the terminal information of the communication terminal 40 and registration of advertisement management source information. The terminal & communication management system 41 notifies the server 42 of cancellation of registration of the communication terminal 40 (step S33).

The above-described terminal & communication management system 41 and the sequence operation of the advertisement management system are achieved by executing a pre-stored operation program by CPUs 21 and 31. As shown in FIG. 6A, the CPU 21 is comprised of a search unit 211 which executes URL search operation after step S22 in FIG. 4, a notification unit 212 which executes step S23 in FIG. 4, a transmission unit 213 which executes step S26 in FIG. 4, a request unit 214 which executes step S28 in FIG. 4, and a display control unit 215 which performs display control in step S31. The CPU 31 is formed from a registration unit 311 which executes step S21 in FIG. 4.

As has been described above, the present invention enables broadcasting advertisement data such as an advertisement broadcast system or Internet advertisement server to a portable communication terminal, and displaying the advertisement data on the screen of the portable communication terminal in no-use. This gives an advertisement broadcaster a great advertisement effect. The terminal user can provide an advertisement space which does not inhibit normal use to the advertisement broadcaster. If the advertisement broadcaster bears part of the communication charge of the terminal user and part of the terminal cost, the terminal user can expect a discount on communication charge, and can get a terminal at low cost.

What is claimed is:

1. An advertisement system comprising:
a portable communication terminal capable of displaying an advertisement on a standby screen;
a terminal management device for managing said portable communication terminal; and
an advertisement broadcast device for storing advertisement data provided by an advertisement broadcaster,
wherein said terminal management device has
notification means for, when a registration request for first information representing that said portable communication terminal is an advertisement display terminal and second information representing an advertisement broadcaster designated by said portable communication terminal is issued, notifying said advertisement broadcast device of the registration request including the first information in accordance with the second information,
registration means for registering the first information and the second information when said advertisement broadcast device sends registration acceptance in response to the registration request notification from said notification means, and
display control means for, when advertisement data is received from said advertisement broadcast device which is a registration acceptance notification source, transmitting the received advertisement data to said portable communication terminal on the basis of the registered first information and the registered second information, and displaying the advertisement data on the standby screen of said portable communication terminal.

2. A system according to claim 1, wherein when a registration cancel request for said portable communication terminal is issued, said registration means cancels registration of the first information and the second information, and said notification means notifies said advertisement broadcast device of cancellation of registration of said portable communication terminal.

3. An advertisement system comprising:
a portable communication terminal capable of displaying an advertisement on a standby screen;
a terminal management device for managing said portable communication terminal;
a server which is connected to Internet and has a plurality of advertisement pages that store advertisement data; and
an advertisement management device for managing each advertisement page of said server,
wherein said advertisement management device has registration means for registering URL of an advertisement page in said terminal management device, and
said terminal management device has
search means for, when said portable communication terminal sends URL of an Internet page, searching URLs registered by said registration means for the sent URL,
notification means for notifying said advertisement management device of the searched URL when said search means finds out the URL,
transmission means for, when said advertisement management device sends back registration acceptance in response to the URL notification from said notification means, transmitting the registration-accepted URL to said portable communication terminal,
request means for, when a transmission request for advertisement data of an advertisement page corresponding to the URL is received from said portable communication terminal in response to transmission of the URL, requesting transmission of the advertisement data corresponding to URL of said server, and
display control means for, when the advertisement data is received from said server in response to the advertisement data transmission request, transmitting the received advertisement data to said portable communication terminal, and displaying the advertisement data on the standby screen.

4. A system according to claim 3, wherein when said portable communication terminal sends cancel information based on cancel of the standby screen, said notification means notifies said advertisement management device of the cancel information.

5. An advertisement display method in a system having
a portable communication terminal capable of displaying an advertisement on a standby screen,
a terminal management device for managing the portable communication terminal, and
an advertisement broadcast device for storing advertisement data provided by an advertisement broadcaster, comprising the steps of:
when a registration request for first information representing that the portable communication terminal is an advertisement display terminal and second information representing an advertisement broadcaster designated by the portable communication terminal is issued, sending a registration request notification including the first information from the terminal management device to the advertisement broadcast device;
registering the first information and the second information in the terminal management device when the advertisement broadcast device sends registration acceptance;
when the advertisement broadcast device which has sent registration acceptance transmits advertisement data, transmitting the advertisement data from the terminal management device to the portable communication terminal in accordance with the registered first information and the registered second information; and
displaying the advertisement data transmitted from the terminal management device on the standby screen of the portable communication terminal.

6. A method according to claim 5, further comprising the steps of:
canceling registration of the first information and the second information by the terminal management device upon reception of a registration cancel request from the portable communication terminal; and
at the same time, notifying the advertisement broadcast device from the terminal management device of cancellation of registration of the portable communication terminal.

7. An advertisement display method in a system having
a portable communication terminal capable of displaying an advertisement on a standby screen,
a terminal management device for managing the portable communication terminal,
a server which is connected to Internet and has a plurality of advertisement pages that store advertisement data, and
an advertisement management device for managing each advertisement page of the server, comprising the steps of:
registering URL of an advertisement page from the advertisement management device in the terminal management device;
when the portable communication terminal sends URL of an Internet page, searching registered URLs for the sent URL to notify the advertisement management device from the terminal management device of the searched URL;
when the advertisement management device sends registration acceptance in response to the URL notification, transmitting the registration-accepted URL from the terminal management device to the portable communication terminal;
when the portable communication terminal requests transmission of advertisement data of a corresponding advertisement page in response to transmission of the URL, requesting transmission of the advertisement data corresponding to the URL of the server from the terminal management device;
when the advertisement data is received from the server in response to the advertisement data transmission request, transmitting the received advertisement data from the terminal management device to the portable communication terminal; and
displaying the advertisement data transmitted from the terminal management device on the standby screen of the portable communication terminal.

8. A method according to claim 7, further comprising the step of, when the portable communication terminal sends a registration cancel request, notifying the advertisement management device from the terminal management device of the registration cancel request.

9. An advertisement display program in a system having
a portable communication terminal capable of displaying an advertisement on a standby screen,
a terminal management device for managing the portable communication terminal, and
an advertisement broadcast device for storing advertisement data provided by an advertisement broadcaster, comprising a program which executes the steps of:
when a registration request for first information representing that the portable communication terminal is an advertisement display terminal and second information representing an advertisement broadcaster designated by the portable communication terminal is issued, sending a registration request notification including the first information from the terminal management device to the advertisement broadcast device;
registering the first information and the second information in the terminal management device when the advertisement broadcast device sends registration acceptance;
when the advertisement broadcast device which is a registration acceptance notification source transmits advertisement data, transmitting the advertisement data from the terminal management device to the portable communication terminal in accordance with the registered first information and the registered second information; and
displaying the advertisement data transmitted from the terminal management device on the standby screen of the portable communication terminal.

10. A program according to claim 9, further comprising a program which executes the steps of:
canceling registration of the first information and the second information by the terminal management device upon reception of a registration cancel request from the portable communication terminal; and
at the same time, notifying the advertisement broadcast device from the terminal management device of cancellation of registration of the portable communication terminal.

11. An advertisement display program in a system having
a portable communication terminal capable of displaying an advertisement on a standby screen,
a terminal management device for managing the portable communication terminal,
a server which is connected to Internet and has a plurality of advertisement pages that store advertisement data, and
an advertisement management device for managing each advertisement page of the server, comprising a program which executes the steps of:
registering URL of an advertisement page from the advertisement management device in the terminal management device;
when the portable communication terminal in no-use sends URL of an Internet page, searching registered URLs for the sent URL to notify the advertisement management device from the terminal management device of the searched URL;
when the advertisement management device sends registration acceptance in response to the URL notification, transmitting the registration-accepted URL from the terminal management device to the portable communication terminal;
when the portable communication terminal requests transmission of advertisement data of an advertisement page corresponding to the URL in response to transmission of the URL, requesting transmission of the advertisement data corresponding to the URL of the server from the terminal management device;
when the advertisement data is received from the server in response to the advertisement data transmission request, transmitting the received advertisement data from the terminal management device to the portable communication terminal; and
displaying the advertisement data transmitted from the terminal management device on the standby screen of the portable communication terminal.

12. A program according to claim 11, further comprising a program which executes the step of, when the portable communication terminal sends a registration cancel request, notifying the advertisement management device from the terminal management device of the registration cancel request.
